(19) United States
(12) Patent Application Publication
(10) Pub. No.: US 2006/0077955 A1
(43) Pub. Date: Apr. 13, 2006

(54) System and methods for a survivable remote network

(76) Inventors: Behrouz Poustchi, Ottawa (CA); David T.L. Bingham, Nepean (CA)

Correspondence Address: SMART & BIGGAR/FETHERSTONHAUGH & CO.;P.O. BOX 2999, STATION D, 900-55 METCALFE STREET, OTTAWA, ON, K1P5Y6, CA

(21) Appl. No.: 10/960,225

(22) Filed: Oct. 8, 2004

(51) Int. Cl. H04L 12/66; H04L 12/56; H04L 12/28

(52) U.S. Cl. 370/352; 370/401

(57) ABSTRACT

Systems and methods for a Survivable Branch Office are provided by embodiments of the invention. The Survivable Branch Office includes a plurality of interconnected packet-based network devices, wherein the Branch Office is adapted to operate in a first mode during which centralized telephony call processing services are supplied to the Branch Office by a Main Office via a connection between the Branch Office and the Main Office. The Branch Office is also adapted to operate in a second mode when the connection between the Branch Office and the Main Office is interrupted. In the second mode the plurality of interconnected packet-based network devices collectively provide telephony call processing services in a distributed manner for the Branch Office. The network devices in some instances are packet-based peer-to-peer terminal sets, wherein the terminal sets themselves can collectively provide required telephony services normally supplied by the Main Office, by operating in a peer-to-peer mode when connection is lost with the Main Office.

### FIELD OF THE INVENTION

The invention relates to telecommunications systems, in particular systems for providing telephony services.

### BACKGROUND OF THE INVENTION

Some modern communications solutions are based on VoIP (Voice-over IP (Internet Protocol)) technology, which involves the transmission of calls over a data network based on IP. The communication is in the form of packet data and thus there is no fixed connection as there would be in the case of switched networks. The communication can be text, voice, graphics or video. In order to simplify IP communication problems, standards have been developed and adopted in the industry. Examples of such standards are H.323 (Packet based communication systems) and SIP (Session Initiation protocol). These standards are followed when designing new hardware and software. The SIP standard covers the technical requirements to set-up, modify and tear down multimedia sessions over the Internet. A multimedia communication session between two endpoints will be referred to as a call.

In a conventional large enterprise VoIP system, a central call processing element, for example a proxy server or a soft-switch provides a switching intelligence across the VoIP telephony network. The central call processing element is typically located at a Main Office. Elements and telephony services are managed by this element, for instance gateway interfaces to service provider networks, messaging services such as voice mail and unified messaging, automatic attendant functions, individual terminal set configuration and network operations. In such a network, some users are located near the Main Office while others are grouped in remote locations, known as Branch Offices. Typically, the Branch Offices will use the services of the Main Office proxy server or soft-switch, the telephony services being accessed through dedicated leased lines or virtual private network (VPN) services over a service provider's IP network.

A problem faced by a conventional Branch Office is a loss of telecommunications capabilities due to a failure that isolates the Branch Office from the Main Office. The failure may result from any number of reasons such as due to a power failure, a failure of a service provider network, or a VPN failure. Unless the Branch Office has a back-up switch to provide telephony services, the Branch Office is left without telephony services that are normally provided by the Main Office when a loss of telecommunications capabilities is experienced between the Branch Office and the Main Office. A back-up switch sufficient to provide telephony services can be a costly proposition as the switch is an expensive component. This defeats potential cost savings from implementing a Branch Office that is capable of using the telephony services of a Main Office in the above-described manner.

### SUMMARY OF THE INVENTION

According to a first aspect of the invention, there is provided a remote network comprising a plurality of interconnected packet-based network devices, the remote network adapted to: operate in a first mode during which centralized telephony call processing services are supplied to the remote network by a main network via a connection between the remote network and the main network; and operate in a second mode when the connection between the remote network and the main network is interrupted, wherein when in the second mode the plurality of interconnected packet-based network devices provide telephony call processing services in a distributed manner for the remote network.

According to an embodiment of the first aspect, the remote network further comprises a continuity detector for determining continuity of the connection between the remote network and the main network.

According to another embodiment of the first aspect, the remote network is adapted to maintain call processing information when the remote network is operating in the second mode, the call processing information to be forwarded to the main network upon switching from the second mode to the first mode following establishing of a successful connection between the remote network and the main network, the call processing information being used to maintain configuration synchronization between the remote network and the main network.

According to another embodiment of the first aspect, the call processing information is at least one of a group consisting of messages, call data records, configuration parameter changes, and operational logs.

According to another embodiment of the first aspect, the remote network is adapted to receive updated call processing information from the main network when operating in the first mode, the call processing information being used to maintain configuration synchronization between the remote network and the main network.

According to another embodiment of the first aspect, the remote network is adapted to provide peer back-up for a packet-based network device not currently available on the remote network when the remote network is operating in the second mode.

According to a second aspect of the invention, there is provided a packet-based network device adapted for use in a remote network, the packet-based network device adapted to: operate in a first mode during which the packet-based network device supports centralized telephony call processing services from a main network; and operate in a second mode when centralized telephony call processing services from the main network are interrupted, wherein when in the second mode telephony call processing services are provided in a distributed manner by a plurality of interconnected packet-based network devices in the remote network.

According to an embodiment of the second aspect, the packet-based network device further comprises a continuity detector for determining continuity of the connection between the remote network and the main network.

According to another embodiment of the second aspect, the packet-based network device is adapted to maintain call processing information when the packet-based network device is operating in the second mode, the call processing information to be forwarded to the main network upon switching from the second mode to the first mode following establishing of a successful connection between the packet-based network device the main network, the call processing information being used to maintain configuration synchronization between the remote network and the main network.

According to another embodiment of the second aspect, the packet-based network device is adapted to receive updated call processing information from the main network when operating in a first mode, the call processing information being used to maintain configuration synchronization between the packet-based network device and the main network.

According to another embodiment of the second aspect, the packet-based network device is adapted to provide peer back-up for a packet-based network device not currently available on the remote network when the remote network is operating in the second mode.

According to a third aspect of the invention, there is provided a method for operation of a remote network comprising a plurality of interconnected packet-based network devices, the method comprising the steps of: detecting an interruption in a connection with a main network; switching from a first mode during which centralized telephony call processing services are supplied to the remote network by the main network to a second mode during which the plurality of interconnected packet-based network devices provides telephony call processing services in a distributed manner for the remote network when centralized telephony call processing services are unavailable from the main network; providing telephony call processing services for the remote network; detecting resumption of connectivity with the main network; switching back to the first mode from the second mode.

According to an embodiment of the third aspect, the method further comprises a start-up step, the start-up step comprising the steps of: beginning operation in the second mode; and switching to the first mode when availability of a proxy server in the main network is detected.

According to another embodiment of the third aspect, the step of beginning operation further comprises: determining if there is a connection to the proxy server; if there is a connection to the proxy server obtaining local configuration files for a respective packet-based network device of the plurality of packet-based network devices from the proxy server and storing the local configuration files on the respective packet-based network device; determining if there are local configuration files stored on the respective packet-based network device; if there are local configuration files stored on the respective packet-based network device, populating a database of the respective packet-based network device with the local configuration files; if there are no local configuration files, populating the database of the respective packet-based network device with default information files; and entering the second mode.

According to another embodiment of the third aspect, the step of detecting an interruption comprises polling the main network at a predetermined interval with an expectation of a response, wherein a received response indicates an uninterrupted connection between the remote network and the main network and a lack of a received response indicates an interrupted connection between the remote network and the main network.

According to another embodiment of the third aspect, the step of providing telephony call processing services further comprises a step of the remote network maintaining call processing information to be forwarded to a proxy server in the main network upon switching back to the first mode from the second mode following resumption of connectivity between the remote network and the main network.

According to another embodiment of the third aspect, the step of detecting resumption of connectivity comprises polling the main network at a predetermined interval with an expectation of a response, wherein a received response indicates resumption of the connection between the remote network and the main network and a lack of a received response indicates the connection between the remote network and the main network remains interrupted.

According to another embodiment of the third aspect, the step of switching back to the first mode from the second mode comprises: passing control of telephony call processing services from the remote network to a proxy server in the main network; pushing call processing information maintained by the remote network during the interruption of the connection between the remote network and the main network from each packet-based network device of the plurality of packet-based network devices to the proxy server.

According to a fourth aspect of the invention, there is provided a method for operation of a packet-based network device in a remote network, the method comprising the steps of: detecting an interruption in a connection with a main network; switching from a first mode during which centralized telephony call processing services are supplied to the packet-based network device by the main network to a second mode during which the packet-based network device is adapted to provide telephony call processing services in conjunction with a plurality of interconnected packet-based network devices in a distributed manner to the remote network when centralized telephony call processing services are unavailable from the main network; providing telephony call processing services for the remote network; detecting resumption of connectivity with the main network; switching back to the first mode from the second mode.

According to an embodiment of the fourth aspect, the method further comprises a start-up step, the start-up step comprising the steps of: beginning operation in the second mode; and switching to the first mode when availability of a proxy server in the main network is detected.

According to another embodiment of the fourth aspect, the step of beginning operation further comprises: determining if there is a connection to the proxy server; if there is a connection to the proxy server obtaining local configuration files for the packet-based network device from the proxy server and storing the local configuration files on the packet-based network device; determining if there are local configuration files stored on the packet-based network device; if there are local configuration files stored on the packet-based network device, populating a database of the packet-based network device with the local configuration files; if there are no local configuration files, populating the database of the packet-based network device with default information files; and entering the second mode.

According to another embodiment of the fourth aspect, the step of detecting an interruption comprises polling the main network at a predetermined interval with an expectation of a response, wherein a received response indicates an uninterrupted connection between the packet-based network device and the main network and a lack of a received response indicates an interrupted connection between the packet-based network device and the main network.

According to another embodiment of the fourth aspect, the step of providing telephony call processing services further comprises a step of the packet-based network device maintaining call processing information to be forwarded to a proxy server in the main network upon switching back to the first mode from the second mode following resumption of connectivity between the packet-based network device and the main network.

According to another embodiment of the fourth aspect, the step of detecting resumption of connectivity comprises polling the main network at a predetermined interval with an expectation of a response, wherein a received response indicates resumption of the connection between the packet-based network device and the main network and a lack of a received response indicates the connection between the packet-based network device and the main network remains interrupted.

According to another embodiment of the fourth aspect, the step of switching back to the first mode from the second mode comprises: passing control of telephony call processing services from the packet-based network device to a proxy server in the main network; pushing call processing information maintained by the packet-based network device during the interruption of the connection between the packet-based network device and the main network to the proxy server.

According to a fifth aspect of the invention, there is provided a system comprising: a main network comprising a proxy server adapted to provide centralized telephony call processing services; a remote network comprising a plurality of packet-based network devices, the remote network adapted to operate in a first mode during which centralized telephony call processing services are supplied to the remote network by a main network via a connection between the remote network and the main network and operate in a second mode when the connection between the remote network and the main network is interrupted, wherein when in the second mode the plurality of packet-based network devices provides telephony call processing services in a distributed manner for the remote network; and the connection between the remote network and the main network.

According to an embodiment of the fifth aspect, the connection is a wide area network (WAN).

According to another embodiment of the fifth aspect, the connection is any one of a group consisting of a dedicated leased line, a virtual private network (VPN), and a service provider internet protocol (IP) network.

According to another embodiment of the fifth aspect, the main network of the system further comprises a remote network agent adapted to aid in maintaining configuration synchronization between each packet-based network device of the plurality of packet-based network devices and the main network.

According to another embodiment of the fifth aspect, the remote network agent is adapted to notify a particular packet-based network device of the plurality of packet-based network devices of configuration parameter changes originating from the proxy server in the main network and deliver the configuration parameter changes when requested by the particular packet-based network device.

According to another embodiment of the fifth aspect, the remote network agent is adapted to receive configuration parameter changes originating from a particular packet-based network device of the plurality of packet-based network devices and deliver the configuration parameter changes to the proxy server in the main network.

According to another embodiment of the fifth aspect, the remote network further comprises an interface for connecting to an external network.

According to another embodiment of the fifth aspect, the interface is for connecting to a public switched telephone network (PSTN).

According to a sixth aspect of the invention, there is provided a method for propagation of configuration parameter changes between a remote network agent in a main network and a remote network, the method comprising: notifying the remote network of a configuration parameter change; and delivering to the remote network the configuration parameter change.

According to an embodiment of the sixth aspect, the step of notifying comprises; the remote network agent being notified of the configuration parameter change for a packet-based network device in the remote network; the remote network agent acknowledging receiving notification of the configuration parameter change; the remote network agent identifying the particular packet-based network device in the remote network due for the configuration parameter change; the remote network agent notifying the particular packet-based network device due for the configuration parameter change; the remote network agent assigning a transaction identifier to the configuration parameter change and storing the configuration parameter change until delivery to the particular packet-based network device is confirmed; and the remote network agent supplying notification, including the transaction identifier, of the configuration parameter change to the particular packet-based network device.

According to another embodiment of the sixth aspect, the step of delivering comprises; a particular packet-based network device sending a request, including a transaction identifier, to the remote network agent for delivery of the configuration parameter change; the remote network agent delivering the configuration parameter change to the particular packet-based network device; the remote network agent receiving a confirmation receipt after the particular packet-based network device has received the confirmation parameter change; the remote network agent deleting the stored configuration parameter change; and the remote network agent notifying the particular packet-based network device that the delivery of the configuration parameter change is complete.

According to a seventh aspect of the invention, there is provided a computer readable medium having embodied thereon computer programmable code for operation of a packet-based network device in a remote network, the computer programmable code comprising: code means for detecting an interruption in a connection with a main network; code means for switching from a first mode during which centralized telephony call processing services are supplied to the remote network by the main network to a second mode during which the packet-based network device is adapted to provide telephony call processing services in conjunction with a plurality of interconnected packet-based network devices, each having the computer programmable code, in a distributed manner for the remote network when centralized telephony call processing services are unavailable from the main network; code means for providing telephony call processing services for the remote network; code means for detecting resumption of connectivity with the main network; code means for switching back to the first mode from the second mode.

According to an embodiment of the seventh aspect, the computer readable medium further comprises code means for initialization of the packet-based network device, the initialization code means comprising: code means for beginning operation in the second mode; and code means for switching to the first mode when availability of a proxy server in the main network is detected.

According to another embodiment of the seventh aspect, the computer readable medium further comprises code means for communicating with a remote network agent in the main network.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Preferred embodiments of the invention will now be described with reference to the attached drawings in which:

FIG. 1 is a schematic of a system including a Main Office and a Branch Office provided by an embodiment of the invention;

FIG. 2 is a block diagram illustrating a system architecture for a survivable Branch Office capability as provided by an embodiment of the invention;

FIG. 3 is a signaling flow chart illustrating a method for isolation detection provided by an embodiment of the invention;

FIG. 4 is a flow chart illustrating a method for configuring a network device during start-up of the network device provided by an embodiment of the invention;

FIG. 5 is a flow chart illustrating a method for performing server-based configuration changes provided by an embodiment of the invention; and

FIG. 6 is a signaling flow chart illustrating an example of notification of configuration changes and transferring configuration data provided by an embodiment of the invention;

FIG. 7 is a functional block diagram of software operating on a peer-to-peer network device in the Branch Office of FIG. 1; and

FIG. 8 is a flow chart for a method of initiating a call from a first network device to a second network device, the methods employing backup network devices if the second network device is not available.

### DETAILED DESCRIPTION OF THE PREFERRED EMBODIMENTS

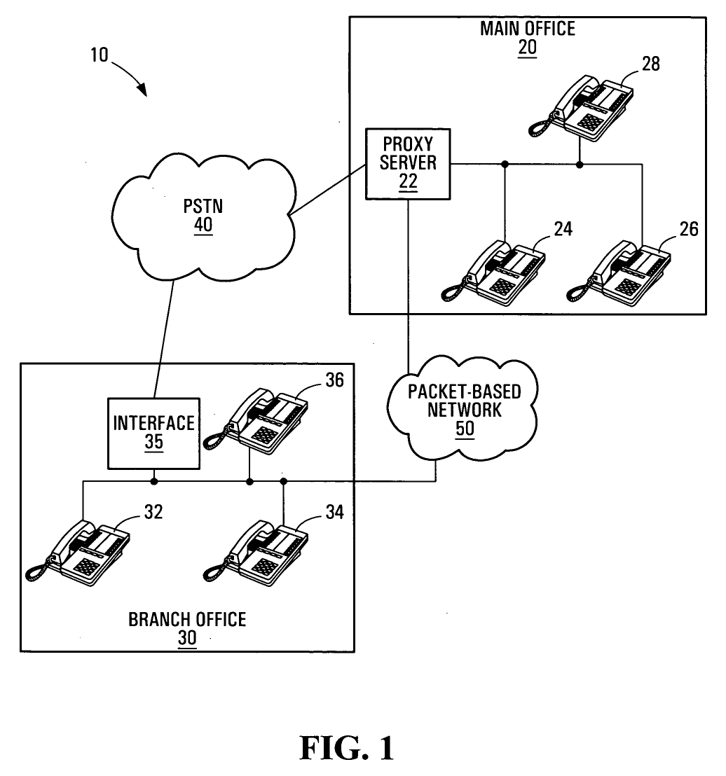

Referring to FIG. 1, a system 10 provided by an embodiment of the invention including a Main Office 20 and a Branch Office 30 will now be described.

The system 10 includes the Main Office 20, the Branch Office 30, a public switched telephone network (PSTN) 40, and a packet-based network 50 coupling the Main Office 20 and the Branch Office 30. The Main Office 20 is considered to be a main network and is comprised of a proxy server 22 and three VoIP terminal sets 24,26,28 coupled to the proxy server. The Branch Office 30 is considered to be a remote network and is comprised of three VoIP peer-to-peer terminal sets 32,34,36 that are interconnected. FIG. 1 also includes an interface 35 for connecting the Branch Office 30 to the PSTN 40. The proxy server 22 of the Main Office 20 is coupled to the PSTN 40. The Branch Office 30 is also coupled to the PSTN 40 via the interface 35. The proxy server 22 of the Main Office 20 is coupled to the packet-based network 50. The Branch Office 30 is also coupled to the packet-based network 50 via the interface 35.

The peer-to-peer terminal sets 32,34,36 of the Branch Office 30 are capable of operating in two modes. In a first mode, referred to hereafter as a proxy mode, the peer-to-peer terminal sets 32,34,36 operate in a manner in which they use telephony services and features as supplied from the proxy server 22. In a second mode, referred to hereafter as a peer-to-peer mode, the peer-to-peer terminal sets 32,34,36 operate in a manner that the peer-to-peer terminal sets 32,34,36 provide local telephony services and features in a distributed manner for the peer-to-peer terminal sets 32,34,36.

In normal operation the proxy server 22 or soft-switch provides switching and telephony features for terminal sets 24,26,28 of the Main Office 20 and for peer-to-peer terminal sets 32,34,36 of the Branch Office 30. Centralized features such as voice mail and auto attendant features are included in some embodiments of the system. Terminal sets 24,26,28 of the Main Office 20 are shown to be collocated with the proxy switch 22 in FIG. 1 and in some embodiments the terminal sets 24,26,28 are coupled to the proxy switch 22 over a local area network (LAN). Terminal sets 32,34,36 of the Branch Office 30 and interface 35 are shown to be collocated and in some embodiments the terminal sets 32,34,36 are interconnected by a LAN local to the Branch Office 30.

The peer-to-peer terminal sets 32,34,36 operate in the proxy mode as described above during normal operation of the system. The Main Office 20 and the Branch Office 30 are coupled together by the packet-based network 50. Services provided by the proxy server 22 are made available to the Branch Office 30 via the packet-based network 50.

In normal operation, the peer-to-peer terminal sets 32,34,36 use the packet-based network 50 and proxy server 22 to contact or be contacted by terminal sets in the Main Office 20 or to contact or be contacted by terminal sets external to the Main Office 20 and Branch Office 30 that are connected to the PSTN 40.

When a failure occurs causing a loss of communication between the Main Office 20 and the Branch Office 30, the Branch Office 30 is isolated from the telephony services provided by the proxy switch 22. At this time the peer-to-peer terminal sets 32,34,36 switch from the proxy mode of operation to the peer-to-peer mode of operation as described above.

The peer-to-peer terminal sets 32,34,36 are capable of detecting when isolation of the Branch Office 30 from the Main Office 20 occurs coincident with the loss of telecommunications capabilities between the Branch Office 30 and the Main Office 20. The peer-to-peer terminal sets 32,34,36 are similarly capable of detecting a resumption of connectivity between the Branch Office 30 and the Main Office 20 after communication is restored.

When operating in the peer-to-peer mode the peer-to-peer terminal sets 32,34,36 use the interface 35 for connecting to the PSTN 40.

FIG. 1 shows an embodiment of the system 10 with three terminal sets in the Main Office 20 and three peer-to-peer terminal sets in the Branch Office 30. This is but one example and it is to be understood that the Main Office 20 can include any number of terminal sets as desired and the Branch Office 30 can include any number of peer-to-peer terminal sets as desired.

The terminal sets 24,26,28 in the Main Office 20 and the peer-to-peer terminal sets 32,34,36 in the Branch Office 30 are described as being connected by a LAN, for example, all terminals may be connected to Ethernet ports on a single IP switch. More generally, the terminal sets 24,26,28 in the Main Office 20 may be connected by any type of network capable of connecting the terminal sets 24,26,28 in an appropriate manner. In a similar manner, the peer-to-peer terminal sets 32,34,36 in the Branch Office 30 may be connected by any type of network capable of connecting the terminal sets 32,34,36 in an appropriate manner.

The interface 35 may be a thin trunk interface (TTI) as described in U.S. Provisional Patent Application No. 60/434,813 entitled “DISTRIBUTED PEER-TO-PEER VOICE MAIL SYSTEM, METHOD AND TELEPHONE TERMINALS” and filed Dec. 20, 2002. More generally, the interface 35 is any interface that allows protocol conversion between a protocol used between interconnected peer-to-peer terminal sets 32,34,36 in the Branch Office 30 and a protocol used over the PSTN 40. In some embodiments, the interface 35 is an internet protocol interface (IPI) to connect the Branch Office to a second packet-based network (not shown) used for communication between the Branch Office and devices external to the Branch Office.

The packet-based network 50 shown in FIG. 1 is any network capable of being used to connect the Main Office 20 and the Branch Office 30, for example a wide area network (WAN) over the public Internet. In some embodiments, the packet-based network is a VPN operated over a service provider network. In some embodiments the packet-based network is a dedicated leased line service.

In FIG. 1, peer-to-peer terminal sets 32,34,36 in the Branch Office 30 are packet-based terminal sets. In some cases, the terminal sets are for example IP phones such as that manufactured by Mitel, Nortel, Avaya, Siemens, NEC, Pingtel or 3COM. More generally, the terminal sets are network devices. Other examples of network devices are a video phone, a PDA (Personal Digital Assistants), a wireless device, a computer supporting peer-to-peer voice over packet-based communication or a wireless telephone that can be suitably programmed and configured. In some embodiments, the terminal sets 24,26,28 of the Main Office 20 are network devices of any of the types described above.

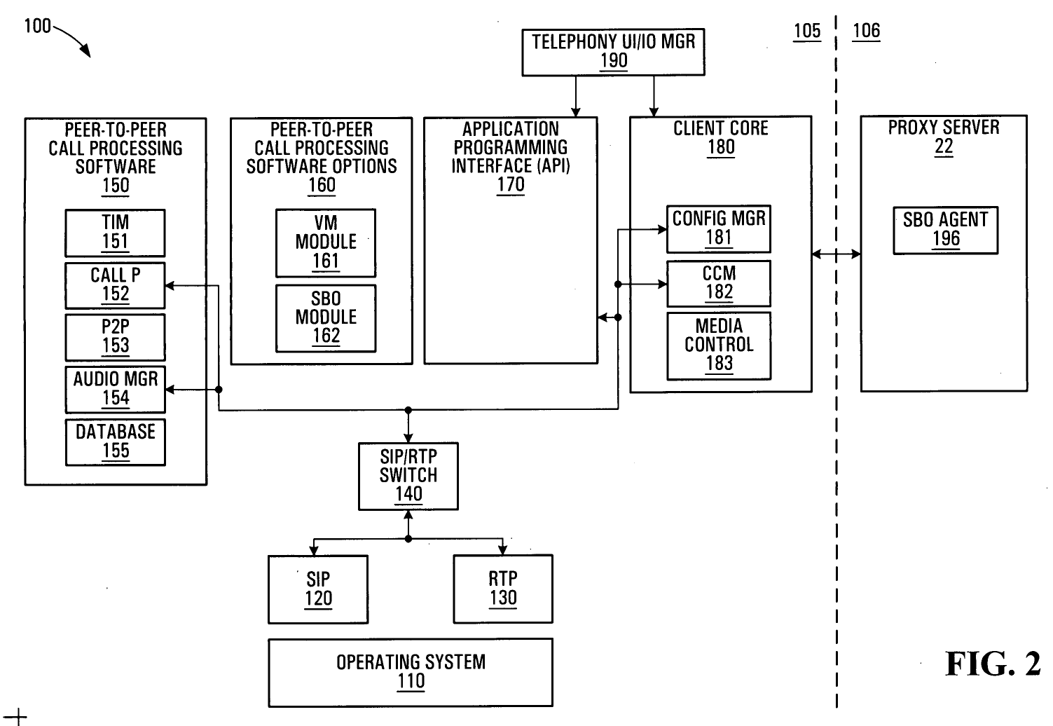

Referring to FIG. 2, a system architecture 100 for an embodiment of a survivable branch office provided by the invention will now be described.

The system architecture 100 of FIG. 2 is comprised of modules generally indicated by 105 that are located at the Branch Office 30 in network devices such as terminal sets 32,34,36 or interface 35, and modules that are generally indicated by 106 that are located at the Main Office 20 for example in the proxy server 22. The modules 106 at the Main Office 20 include a Survivable Branch Office (SBO) agent 196 in the proxy server 22, which will be discussed in more detail below. The modules 105 located at the Branch Office 30 include an operating system 110, Session Initiation Protocol (SIP) stack software 120, a Real-Time Protocol (RTP) stack software 130, a SIP/RTP switch 140, a peer-to-peer call processing software module 150, a peer-to-peer call processing application software options module 160, an application programming interface (API) 170 for the peer-to-peer call processing software module 150, a client core 180, and a telephony user interface/input output (UI/IO) manager 190.

The operating system 110 refers to an operating system software on a peer-to-peer terminal set such as peer-to-peer terminal sets 32,34,36 of FIG. 1, but in this architecture the operating system 110 also comprises platform specific hardware/software interfaces and abstraction layers, IP protocol stacks, and supporting software. The SIP stack software 120 is selected by the terminal set vendor or a third party software vendor. In some embodiments the SIP stack software is sharable with other peer-to-peer terminal sets of the Branch Office 30. The RTP stack software 130 provides transport services for VoIP voice traffic. In some embodiments the RTP stack software is sharable with other peer-to-peer terminal sets of the Branch Office 30. The SIP/RTP switch 140 manages the sharing of SIP and RTP protocol streams between a server-based call control manager (CCM) 182 in the client core 180 and the peer-to-peer call processing software module 150. The peer-to-peer call processing software module 150 is comprised of several sub-modules including a Telephony Interface Manager (TIM) 151, which is an abstract interface provided for telephony applications, a call processing component (CALL P) 152, peer-to-peer mechanisms (P2P) 153 for supporting distributed call processing applications, an audio manager 154 acting as an interface to audio services of the network device upon which the peer-to-peer call processing software 150 exists and a database 155 for storing configuration parameters. The peer-to-peer call processing application software options module 160 includes add-on modules such as a voice mail (VM) application module 161 for providing reliable voice mail in a peer-to-peer network and a Survivable Branch Office module 162 for providing features and services used to carry out the survivable Branch Office capability. The client core 180 is a representative set of core components found in a terminal set in a server-based VoIP system with survivable Branch Office capability. Components of the client core 180 include a configuration manager 181 responsible for local management of user and terminal set settings, the call control manager (CCM) 182 for providing an abstract view and interface to the underlying call set-up mechanism, for example SIP for terminal set user interface and call state logic, and a media control sub-module 183 for providing an abstract view and interface to platform-specific audio capabilities and interfaces. The telephony user interface/input output manager 190 provides a consistent user experience for the peer-to-peer terminal set of the Branch Office 30 in both the proxy and peer-to-peer modes.

The proxy server 22 provides call processing and telephony services. In some embodiments the proxy server 22 is a single server. In other embodiments the proxy server 22 is made up of multiple servers. The survivable Branch Office agent 196 is used in sychronization of settings and operational data between the proxy server 22 and the peer-to-peer terminal sets 32,34,36 of the Branch Office 30. In some embodiments the survivable Branch Office agent 196 is used in sychronization of settings and operational data between the proxy server 22 and the interface 35 of the Branch Office 30, for instance if the interface 35 was used as a local gateway under normal use as well as during isolation.

Upon start up of the peer-to-peer terminal set of the Branch Office 30, the Survivable Branch Office module 162 is enabled before the peer-to-peer terminal set will operate in the proxy mode. Prior to being enabled, the peer-to-peer terminal set operates in the peer-to-peer mode. One application in the Survivable Branch Office module 162 is a watcher component. In some embodiments, the watcher component is a protocol-based mechanism used to detect a loss of continuity between the Branch Office 30 and the Main Office 20. In some embodiments, the watcher component is present on only a single peer-to-peer terminal set of the Branch Office 30 and that single terminal set carries out the task of detecting a loss of continuity. In some embodiments, the watcher component is present on more than one peer-to-peer terminal set of the Branch Office 30. In some applications, the watcher component is shared amongst one or more peer-to-peer terminal sets of the Branch Office 30. The Survivable Branch Office module 162 also controls operation of the SIP/RTP switch 140. The Survivable Branch Office module 162 handles switch-over between the proxy and peer-to-peer modes, which includes managing synchronization of configuration data and store voice mail messages as necessary.

The Survivable Branch Office module 162 of the peer-to-peer call processing software application software options module 160 also comprises a configuration broker function to support synchronization of configuration changes. The peer-to-peer terminal set supporting the configuration broker function receives notification of configuration changes made at the proxy server 22. In some embodiments, the peer-to-peer terminal set is interested in changes to its own configuration data. In some embodiments, the peer-to-peer terminal set is interested in changes to any or all of its peers.

The specific components included in FIG. 2 and described above are representative of an embodiment provided by the invention. It is to be understood that embodiments that do not contain all of the specific components described above or that contain additional components, but provide for the functionality of the invention are considered to be within the scope of the invention.

Detection of isolation of the Branch Office 30 from the Main Office 20 is performed by software running on any member of the Branch Office 30, for example a peer-to-peer terminal set or interface 35 and can be performed in a number of different ways that would be understood by one skilled in the art. For example, in some embodiments, detection can be performed by an exchange of “heartbeat” messages over a connectionless line, such as a user datagram protocol (UDP) link, or a connected link for example a transmission control protocol (TCP) link. In some embodiments, a variation of the heartbeat method is performed using specialized SIP messages, for example using the non-standard “PING” SIP method. In some embodiments, a frequently occurring event package in the “Event” header of a SIP subscribe method could be subscribed to and a period of isolation is detected when occurrences of the event stop being detected on a regular basis. In some embodiments, subscribing to an unsupported event package in the “Event” header of a SIP subscribe method results in the return of a “489 Bad Event” response and when no “489 Bad Event” response is returned a period of isolation is detected. These methods are simply used to detect if there is connectivity between the Main Office 20 and the Branch Office 30 and the exact content of the messages is not relevant in itself.

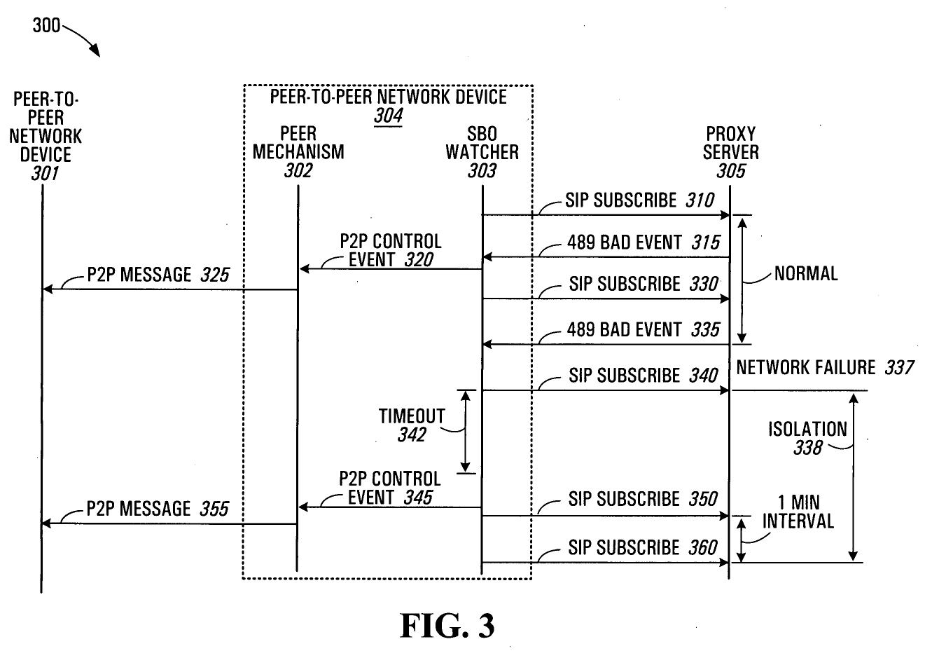

FIG. 3 illustrates a signal flow diagram, generally indicated at 300, of an isolation detection sequence provided by an embodiment of the invention. The signal flow diagram documents signal flow between a first peer-to-peer network device 301 and a second peer-to-peer network device 304, both located in the Branch Office 30 and a proxy server 305 located in the Main Office 20. Peer-to-peer network device 304 includes a watcher component 303 of the type described above in the Survivable Branch Office module 162, as well as a peer mechanism 302 for communicating with other peer-to-peer terminal sets. Peer-to-peer network device 304 is a terminal set that is designated as being responsible for detecting a loss of connectivity between the Branch Office 30 and the Main Office 20. Peer-to-peer network device 301 is another terminal set in the Branch Office 30 that peer-to-peer network device 304 passes along an indication of the connectivity status of Main Office 20 and the Branch Office 30. The proxy server 305 acts as described above with regard to FIGS. 1 and 2.

The peer-to-peer network devices 301,304 are not to be limited to peer-to-peer terminal sets. In some embodiments, a peer-to-peer network device may be an interface, for example interface 35 which has been described above in some embodiments as a TTI.

At step 310 the watcher component 303 sends a “SIP Subscribe” message to subscribe for an unknown event to the proxy server 305. In response, the proxy server 305 sends a “489 Bad Event” message 315 to the watcher component 303. The watcher component 303 sends a message 320 to the peer mechanism 302 as a proxy control event message indicating that there is currently connectivity between the Main Office 20 and the Branch Office 30. In response to this message 320 the peer mechanism 302 sends a peer-to-peer message 325 to peer-to-peer network device 301 indicating that there is currently connectivity between the Main Office 20 and the Branch Office 30. The steps 310 and 315 are repeated in steps 330 and 335. A network failure 337 is noted to occur following the “489 Bad Event” message 335, which indicates a beginning of a period of isolation 338. At step 340 the watcher component 303 again sends a “SIP Subscribe” for an unknown event to the proxy server 305. At this point no response is received from the proxy server 305 for an extended period of time. Following a predetermined timeout period 342, the watcher component 303 sends a message 345 to the peer mechanism 302 as a proxy control event message indicating that there is currently no connectivity between the Main Office 20 and the Branch Office 30. In response to this message 345 the peer mechanism 302 sends a message 355 to peer-to-peer network device 301 indicating that there is currently no connectivity between the Main Office 20 and the Branch Office 30. During the period of isolation 338 the watcher component 303 sends “SIP Subscribe”]messages 350,360 to the proxy server 305 at an interval than is larger than a normal interval when connectivity is known to be established. The watcher component 303 sends “SIP Subscribe” messages until a “489 Bad Event” message is received indicating a resumption of connectivity between the Main Office 20 and the Branch Office 30.

In some embodiments, a normal interval is 1 to 10 seconds. In some embodiments, the larger interval during the period of isolation 338 is 1 minute. The intervals suggested for the normal and larger intervals are simply examples of intervals that could be used. More generally the intervals could be any desired time period that is acceptable to users of the system.

When connectivity of the connection between the Main Office 20 and the Branch Office 30 is detected to have resumed the larger interval between “SIP Subscribe” messages returns to the normal interval.

In some embodiments the watcher component 303 sends a proxy control event message to the peer mechanism 305 following every “SIP Subscribe/Bad Event” response message pair. In some embodiments the watcher component 303 sends the proxy control event message to the peer mechanism 305 at a particular iteration of the “SIP Subscribe/Bad Event” response, for example any particular multiple of the subscribe/response message pair. More generally, the watcher component 303 sends the proxy control event message to the peer mechanism 305 at any desired interval. In some embodiments, the peer mechanism 302 sends the peer-to-peer message to the peer-to-peer network device 301 at any desired interval, for example immediately after the watcher component 303 sends the proxy control event message to the peer mechanism 302 or at any other desired interval.

In some embodiments during periods of isolation between the Main Office 20 and the Branch Office 30, the peer-to-peer terminal sets 32,34,36 of the Branch Office 30 use interface 35 to place local, long distance, and/or emergency calls to destinations outside the Branch Office 30. In some embodiments, the peer-to-peer terminal sets of the Branch Office 30 use interface 35 to place local, long distance, and/or emergency calls to destinations outside the Branch Office 30 when the connection between the Main Office 20 and the Branch Office 30 is operational, even though the proxy server 22 is available to route calls to destinations outside the Branch Office 30. In some embodiments, the proxy server 22 can place local calls originating from anywhere in the system 10 though the interface 35 of the Branch Office 30.

In some embodiments during periods of isolation between the Main Office 20 and the Branch Office 30, calls coming in to the Branch Office 30, referred to hereafter as in-calls, are routed using the distributed and interconnected peer-to-peer network of the Branch Office 30. In some embodiments, in-calls are routed using the proxy server 22 when the connection between the Main Office 20 and the Branch Office 30 is operational. In some embodiments, the interface 35 in the Branch Office 30 provides in-call capability at all times. In some embodiments, when in-calls are not supported by the interface 35, the interface 35 shall not pick up incoming calls. This facilitates handling of the in-call by a PSTN switch, for example when the PSTN switch provides features such as forward-no-answer or voice-mail messaging.

In some embodiments, users of peer-to-peer terminal sets 32,34,36 in the Branch Office 30 experience minimal service interruption at the beginning of an isolation period. In some embodiments, users of peer-to-peer terminal sets 32,34,36 in the Branch Office 30 experience minimal or no service interruption at an end of the isolation period upon resumption of connectivity. In some embodiments, a call that has been initiated by a peer-to-peer terminal set 32,34,36 in the Branch Office 30 will continue until the call is terminated by normal user behaviour.

In some embodiments, the survivable Branch Office capability can tolerate periods of isolation for short periods of time when the connection between the Main Office 20 and the Branch Office 30 is operable without causing peer-to-peer terminal sets 32,34,36 of the Branch network 30 to switch from the proxy mode to the peer-to-peer mode. In some embodiments, the survivable Branch Office capability can tolerate periods of connectivity during a period of isolation for short periods of time without causing peer-to-peer terminal sets 32,34,36 of the Branch network 30 to switch from the peer-to-peer mode back to the proxy mode.

In some embodiments, isolation of the Branch Office 30 from the Main Office 20 is detected within 10 seconds. In some embodiments, after isolation is detected between the Branch Office 30 and the Main Office 20 peer-to-peer terminal sets 32,34,36 of the Branch Office 30 switch from the proxy mode to the peer-to-peer mode and begin providing distributed telephony services within 1 second. In some embodiments, after continuity is detected between the Branch Office 30 and the Main Office 20 peer-to-peer terminal sets 32,34,36 of the Branch Office 30 switch back to the proxy mode from the peer-to-peer mode within 1 second. More generally, the times for the above described functions of detecting isolation and switching between the proxy mode and the peer-to-peer mode and vice versa can be any length of time that is acceptable to users of the system.

Upon start-up, a peer-to-peer terminal set in the Branch Office 30 will start operation in the peer-to-peer mode as described above. When the proxy server 22 is detected by the peer-to-peer terminal set, the peer-to-peer terminal set is switched from the peer-to-peer mode to the proxy mode. In some embodiments, a peer-to-peer terminal set has a survivable Branch Office operation flag that is enabled to allow the switch-over from the peer-to-peer mode to the proxy mode. Whether in the proxy or peer-to-peer mode of operation, the peer-to-peer terminal set of the Branch Office 30 operates according to centrally provisioned configuration parameters. The peer-to-peer terminal set obtains the configuration parameters before starting operation in the first or second modes. This provides that an automatic default configuration capability of peer-to-peer operation does not over-ride central provisioning of the proxy server 22.

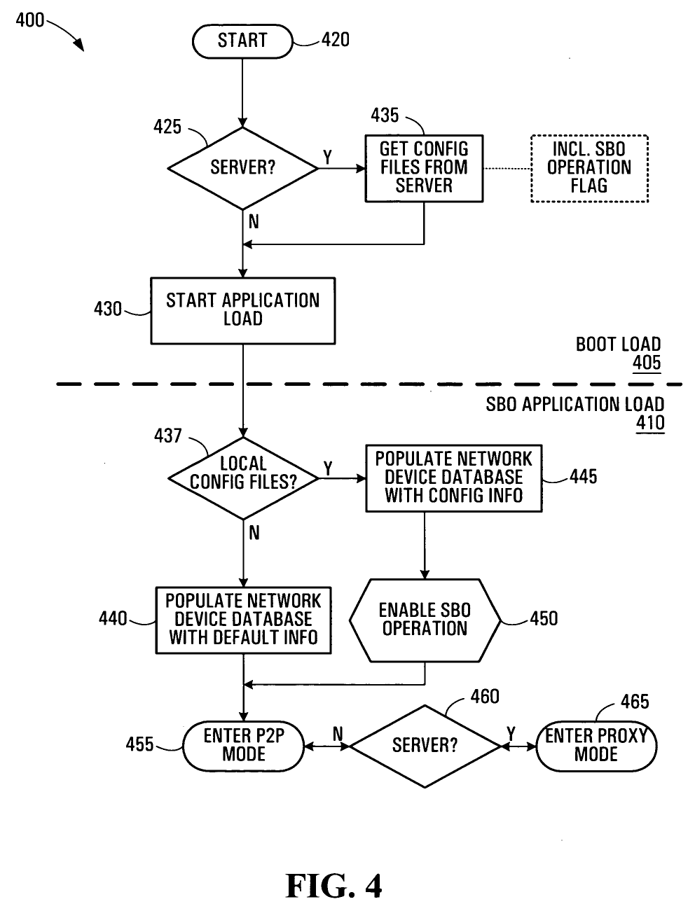

Referring to FIG. 4, a method 400 for a start-up sequence with mode selection according to an embodiment of the invention will now be described. The method 400 is comprised of two distinct operations. A first operation 405 is a general boot loading of the peer-to-peer network device, such as a terminal set. A second operation 410 is a Survivable Branch Office (SBO) application loading of the peer-to-peer terminal set. The first operation 405 includes a first step 420 of turning on the terminal set and starting a boot up process. At step 425 it is to be determined if there is a connection to the proxy server 22. If there is no connection to the proxy server 22 (no path) the peer-to-peer terminal set starts an application load 430. If there is a connection to the proxy server 22 (yes path), configuration files are obtained 435 from the proxy server 22 and stored in local non-volatile memory, such as FLASH, on the network device.

Following step 430, the method 400 enters the second operation 410. At step 437 it is to be determined if there are local configuration files, for example that have been obtained from the proxy server 22 in step 435 or that are already stored in the local non-volatile memory. If there are no local configuration files (no path), default information files are downloaded 440 into a database of the peer-to-peer terminal set. If there are local configuration files (yes path), the local configuration files are downloaded 445 into a database of the peer-to-peer terminal set. Survivable Branch Office operation is enabled at step 450. After the database of the peer-to-peer terminal set has been loaded with data, either default or configuration data, the peer-to-peer terminal set enters the peer-to-peer mode. Once the general boot loading has copied the configuration data or default data from the application load into the network device's memory, control is passed to instructions found in the configuration data or default data. At this point if the proxy server 22 is detected 460 the peer-to-peer terminal set switches 465 from the peer-to-peer mode to the proxy mode. If the proxy server 22 is not detected 460 the peer-to-peer terminal set remains 455 in the peer-to-peer mode.

In some embodiments, the survivable Branch Office operation flag is included in the configuration files obtained from the server at step 435.

The method for the peer-to-peer network device of as described in relation to FIG. 4 is not to be limited to terminal sets. In some embodiments, peer-to-peer network device 301 or 304 may be an interface, for example interface 35 which has been described above in some embodiments as a TTI.

In some embodiments, configuration parameters included in configuration files include system parameters or terminal-specific parameters or both system parameters and terminal-specific parameters. System parameters include at least one of a group consisting of the IP address of the SIP proxy server and descriptions of directory numbers used in the system and external dialing prefixes or other directory numbers of relevance to the user of the peer-to-peer terminal set. Terminal-Specific parameters include at least one of a group consisting of an assigned number for the peer-to-peer terminal set, an assigned user name or a specific name assigned to the terminal set that may be used for example in a corporate directory, call display function parameters or automatic attendant function parameters, terminal-specific dialing rules which may pertain to internal calls only, parameters for a Do-Not-Disturb (DND) feature such as On/Off setting and DND message selection, parameters for a call forward (CF) feature, parameters for a speed dial feature and parameters for a personal directory. The above-described parameters are merely a list of example parameters that may be used as configuration parameters and are not meant to limit the invention to solely the described parameters.

Terminal-Specific configuration parameters described above are kept synchronized between peer-to-peer network devices of the Branch Office 30 and the proxy switch 22. Changes to configuration parameters made on the proxy server 22 while telephony services are supplied to the Branch Office 30 by the Main Office 20 are propagated to the respective peer-to-peer network devices of the Branch Office 30 that the changes are directed to and will affect behaviour of the peer-to-peer network devices as necessary. Changes to configuration parameters made on the peer-to-peer network devices while telephony services are provided by the peer-to-peer network devices in a distributed manner for the Branch Office 30 are propagated to proxy server 22 of the Main Office 20 after connectivity of the connection between the Main Office 20 and the Branch Office 30 has resumed.

Some configuration data is ‘mastered’ by the Main Office in the server database, and that will be forwarded to the Branch Office following the interruption, for example information that would normally be changed only by a system administrator such as a terminal extension number. Other configuration data that is allowed to be modified by users may have changed on a VoIP terminal set during the isolation period while the VoIP terminals are operating in peer-to-peer mode, and such synchronization information will be sent to the server. For example, call-forwarding information or voice mail greeting information. A third class of configuration data is represented by non-configuration data that has been generated on the set during operation in peer-to-peer mode, but belongs in a central server in normal operation, such as voice mail messages.

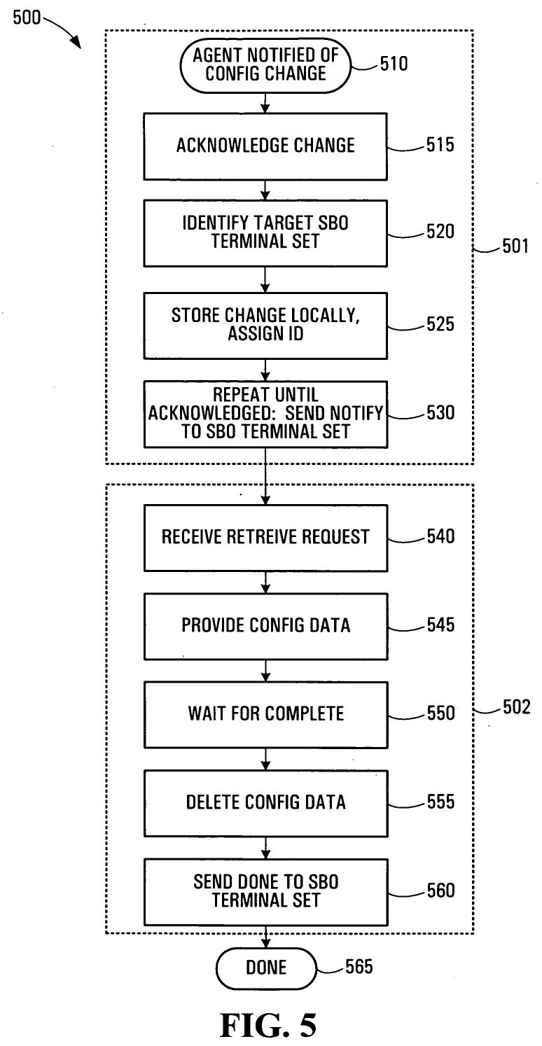

With respect to FIG. 2, the survivable Branch Office agent 196 was identified as being a feature of the survivable Branch Office architecture used in sychronization of settings and operational data between the proxy server 22 and the peer-to-peer terminal sets 32,34,36 of the Branch Office 30. FIG. 5 is a flow chart that will be used to describe a method 500 for the survivable Branch Office agent 196 to notify a peer-to-peer terminal set, referred to hereafter as a target terminal set, of a configuration change and supply configuration change data to the peer-to-peer terminal set. The method 500 is comprised of two sub-processes. A first sub-process 501 is for notification of the target terminal set. A second sub-process 502 is for delivery of configuration change data. The target terminal set drives the second sub-process.

The notification sub-process 501 begins at step 510, wherein the proxy server 22 notifies the survivable Branch Office agent 196 of the configuration change for the target terminal set. The survivable Branch Office agent 196 responds by acknowledging 515 the notification has been received. The survivable Branch Office agent 196 identifies 520 the target terminal set for which it has received the notification of the configuration change. At step 525 the survivable Branch Office agent 196 stores data corresponding to the configuration change and assigns a unique transaction identifier to the change configuration. The survivable Branch Office agent 196 then sends notification 530 of the configuration change to the target terminal set repeatedly until an acknowledgement of receipt is received from the target.

The delivery sub-process 502 begins at step 540, wherein the target terminal set receives the notification of the configuration change and requests the survivable Branch Office agent 196 to send the data comprising the change request. At step 545, sending of the data by the survivable Branch Office agent 196 to the configuration manager 181 occurs in response to the request 540 from the configuration manager 181. The survivable Branch Office agent 196 waits 550 for the data to be completely sent to the target terminal set. After the data has been completely sent by the survivable Branch Office agent 196 the stored data is deleted 555 from where it has been stored in the survivable Branch Office agent 196. Finally at step 560, the survivable Branch Office agent 196 notifies 560 the target terminal set that the data exchange has been completed. The method 500 ends at this point 565 unless there are further transactions directed to the target terminal set. If there are further transactions, an additional notification sub-process 501 is started here.

In some embodiments, if there are multiple configuration changes outstanding for a single terminal set, only a first configuration change is identified during the notification sub-process 501. After the first configuration change has been handled, following transactions are processed in the same manner described above.

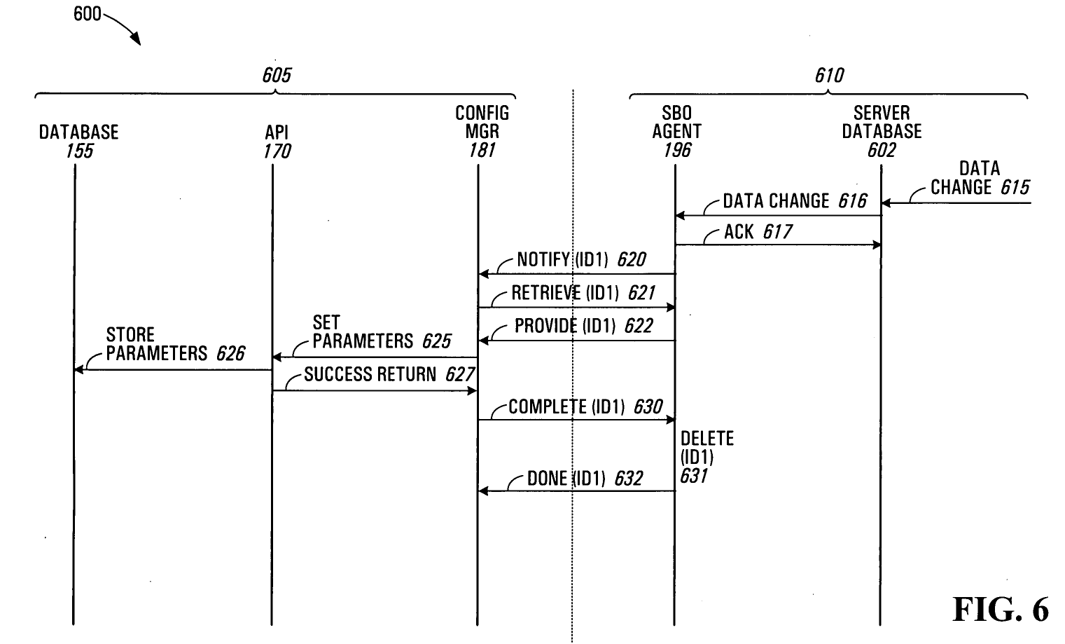

FIG. 6 illustrates a particular example of a signaling flow 600 for a notification of configuration change and subsequent configuration change data exchange. In FIG. 6, the proxy server 610 of the Main Office includes a server database 602 and the Survivable Branch Office agent 196 and the target peer-to-peer network device 605, such as a terminal set or interface device of the Branch Office 30 includes the database 155 associated with the peer-to-peer call processing software 150, the API 170 and the configuration manager 181 of the client core 180.

In a first step 615 the server database 602 is notified of a configuration change for the peer-to-peer terminal set 605. The server database 602 further notifies 616 the Survivable Branch Office agent 196 of the configuration change. The Survivable Branch Office agent 196 sends 617 an acknowledgement of receipt of the configuration change notification to the server database 602. The Survivable Branch Office agent 196 then sends a “Notify” message 620 including the transaction identifier (ID1) to the configuration manager 181 of the target terminal set 605. The “Notify” message indicates that a configuration change has taken place at the proxy server 610 and provides the unique transaction identifier for the ensuing transaction as in step 520 of FIG. 5. The configuration manager 181 responds with a “Retrieve” command 621 that includes the transaction identifier and which requests delivery of the data associated with the indicated transaction. In response to the “Retrieve” command 621, the Survivable Branch Office agent 196 sends a “Provide” message 622 including the configuration change data. The configuration manager 181 uses the configuration change data to initiate the configuration change by setting 625 the parameters corresponding to the configuration data via the API 170. The API 170 in turn, sends 626 the data to the database 155 associated with the peer-to-peer call processing software 150 for storage of the configuration change data. The API 170 sends a “Success Return” message 627 to the configuration manager 181 to notify the configuration manager that the configuration change data has been successfully used to set appropriate parameters and the configuration change data has been stored. The configuration manager then sends a “Complete” message 630 including the transaction identifier to notify the Survivable Branch Office agent 196 of the successful receipt of the configuration change data and that the transaction may be closed. Notification of successful receipt of the configuration change data initiates deleting 631 of configuration change data that was stored in the Survivable Branch Office agent 196 at step 620. The Survivable Branch Office agent 196 then sends a “Done” message 632 to the configuration manager 181 to end the transaction by indicating the transaction is closed.

In some embodiments, the peer-to-peer terminal sets also maintain user data. Examples of such user data are personal directory entries, call lists (e.g. out-going calls/last-number-redial, missed call list).

In some embodiments, real-time data relevant to operation of the proxy switch 22 needs to be generated and used by the peer-to-peer terminal sets 32,34,36 and the interface 35 of the Branch Office 30. For example, Time-of-Day as maintained by the proxy server 22 is used by the peer-to-peer terminal sets. During periods of isolation, TOD remains synchronized in the Branch Office 30 and is used in real-time logging of events.

In some embodiments, the peer-to-peer terminal sets record relevant operational data in non-volatile memory, for example FLASH files. More generally, the operational data can be store in any type of file or memory structure that is available for use and meets the needs of the storage operation. Operational data may contain information such as a type of log information or a reason for logging the information, a time of an event, and any other information such as a new data set or configuration information. In some embodiments, operational logs are stored in a circular buffer allowing a minimum of 1000 events to be stored. More generally, other methods of storage known to those skilled in the art could be used to provide appropriate storage of information.

During switchover from the proxy mode to the peer-to-peer mode, or vice versa, the peer-to-peer terminal set of the Branch Office 30 presents a consistent user interface to a user of the peer-to-peer terminal set. In some embodiments all terminal-based telephony features are operated identically in all modes. In some embodiments, during switch over between modes the peer-to-peer terminal set indicates to the user that services are currently unavailable.

In some embodiments, peer-to-peer network devices support such as VoIP terminal devices or interface 35 access by remote network devices. Such access is supported by conventional open or secure methods, for example telnet or SSH and also depend on the operating environment defined by the peer-to-peer network device vendor. Example of functions that may be supported by such remote network device access are: viewing survivable Branch Office operation logs, clearing survivable Branch Office operation logs, querying current mode and operational state of the peer-to-peer terminal set and/or the survivable Branch Office network, releasing “watcher” operation, displaying peer-to-peer data, suspending peer-to-peer operation which may occur in preparation of a set clear, and clearing all databases on a peer-to-peer terminal set.

In some embodiments during periods of isolation, a peer-to-peer terminal set records call data for calls made by or called to the peer-to-peer terminal set. At the end of the period of isolation the call record is transferred to the proxy server 22.

In some embodiments, telephony services which are centrally provided by the proxy server 22, such as conferencing, user presence or hotelling are supported by the peer-to-peer terminal sets when the peer-to-peer terminal sets are operating in the proxy mode. It is to be understood that the above-identified centrally provided telephony services are merely examples of such services and that the invention is not to be limited to the peer-to-peer terminal sets supporting solely the described centrally provided telephony services. In some embodiments, the centrally provided telephony services may or may not be supported while the peer-to-peer terminal sets operate in the peer-to-peer mode.

In some embodiments, the peer-to-peer terminal sets are able to support upgrades of system software. In some embodiments, the peer-to-peer terminal sets conform to software distribution procedures of the proxy switch 22.

In some embodiments, the existence and operation of the survivable Branch Office capability described above is transparent to users of peer-to-peer terminal sets of the Branch Office.

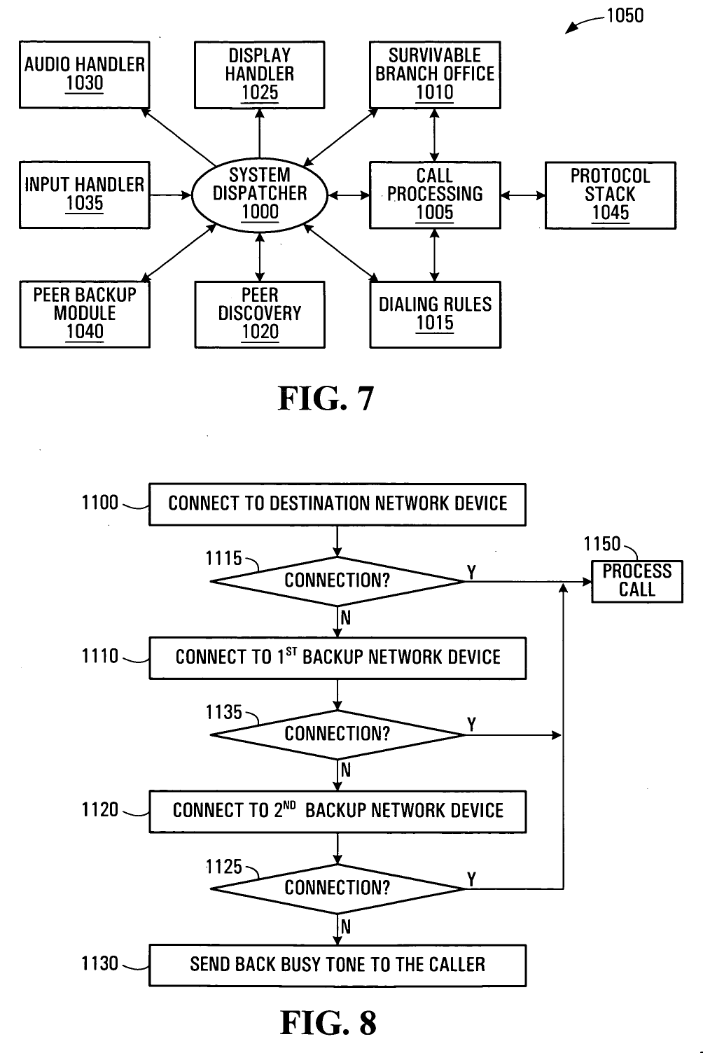

FIG. 7 shows a functional block diagram of software 1050 operating on terminal set 32 of FIG. 1. The software 1050 includes modules for performing particular functions, for example Survivable Branch Office call processing features, as well a module for distributing information between the modules. The software 1050 will be described as operating on terminal set 32; however, it is to be understood that similar software is implemented in every terminal set of the Branch Office 30. Furthermore, in some cases, at least some of the features of the software 1050 described below are implemented in any network device in the Branch Office 30 including interface 35, for example. The software 1050 is stored in RAM and runs on a CPU, both also included in a terminal set such as terminal set 32 or other network devices such as interface 35. More generally, the software 1050 can be implemented as any suitable combination of instructions stored in memory for execution by general or special purpose processors, firmware, ASICs (Application Specific Integrated Circuits), FPGAs (Field-Programmable Gate Arrays), and general or special purpose logic. A system dispatcher 1000 provides communication and scheduling between various functional elements which include a call processing module 1005, a Survivable Branch Office module 1010, a dialing rules module 1015, a peer discovery module 1020, a display handler 1025, an audio handler 1030, an input handler 1035, and a peer back-up module 1040. The call processing module 1005 also interfaces with a protocol stack 1045.

FIG. 7 shows a detailed example of functions that may be included in a network device such as terminal set 32 or interface 35; however, it is to be understood that a network device need not have all of the functions shown in FIG. 7 and that in some implementations a network device will have only some of the functionality shown in FIG. 7. The display handler 1025 formats information and displays the information to a user. The input handler 1035 monitors inputs from for example key presses, hook switch, volume keys, and hands free and mute buttons and informs the system dispatcher 1000. The system dispatcher 1000 then distributes messages to other modules for further appropriate action to be taken. The audio handler 1030 plays audio tones such as ringing, busy, and call waiting tones and/or connects to a handset speaker or speaker phone through a media call upon receipt of an audio message from the system dispatcher 1000.

When terminal set 32 is initially connected to the network of Branch Office 30 it performs a peer discovery by executing the peer discovery module 1020. At this point terminal set 32 undergoes a discovery of peer network devices such as terminal sets 34,36 and other network devices such as interface 35, by way of messages between terminal set 32 and terminal sets 34,36 and interface 35. Once the other terminal sets and network devices are discovered, information is exchanged between the terminal set 32 and the other terminal sets and network devices. At least part of the information exchanged in the messages is included in a routing table.

During periods of isolation the peer-to-peer terminals sets 32,34,36 of the Branch Office 30 provide peer back-up for peer-to-peer terminal sets that are not currently accessible at the Branch Office 30. In particular, when in peer-to-peer mode, if a network device is unavailable to process a call, the call is re-directed to one of its designated backup network devices and the designated backup network device receiving the re-directed call provides call processing functionality for the network device that is unavailable. In some embodiments, the peer-to-peer terminal sets 32,34,36 of the Branch Office 30 each have at least one back-up terminal set which provides back-up support for the unavailable peer-to-peer terminal set when it is not connected to the network of Branch Office 30 or is otherwise not currently accessible. In some embodiments, the back-up terminal sets maintain a copy of all relevant configuration data for the peer-to-peer terminal set requiring back-up and during periods of isolation use this information to provide appropriate call handling. In some embodiments, during periods of connectivity between the Branch Office 30 and the Main Office 20 the proxy server 22 is responsible for handling of calls for peer-to-peer terminal sets 32,34,36 that are currently not accessible.

On a more simplified level, each network device maintains an identification of its designated backup network devices and an address for each designated backup network device. In particular, when a new network device is added to the network of Branch Office 30, the network device makes use of its peer discovery module 1020 to obtain routing information pertaining to other network devices in the network of Branch Office 30 and makes use of the peer backup module 1040 to designate two other network devices as backup network devices.

Referring back to FIG. 7, the dialing rules module 1015 contains and/or applies a set of dialing rules for the call-processing module 1005, which control how calls are directed.

The call-processing module 1005 interacts with the protocol stack 1045 to set up and tear down calls, and to set up media calls.

The call processing modules of a number of network devices collectively serve to deliver PBX-like (Private Branch Exchange-like) call processing capabilities in a distributed fashion without the need for a PBX (Private Branch Exchange). For example, the call processing module 1005 of terminal set 32 handles calls not only intended for terminal set 32 but also handles calls for other network devices for which it has been designated as a backup terminal set.

The Survivable Branch Office module 1010 performs operations as described above.

FIG. 8 shows a flow chart for a method of initiating a call from one network device to another network device, in which the call is directed to a network device in the Branch Office 30 of FIG. 1, in particular when the network devices of the Branch Office 30 are operating in a peer-to-peer mode. In particular, a caller at an originator network device wishes to call a person at a destination network device. The originator network device may be another device within the network of Branch Office 30, a device within the network of the Main Office 20, or a device external to both Offices 20,30 which is coupled to PSTN 40. At step 1100, the originator network device attempts to establish a connection for a call with the destination network device. At step 1105, if the connection is established (yes path) the call is processed normally (step 1150). At step 1105 if the attempt is unsuccessful, then the originator network device looks up its routing information to determine which network device is to serve as a first backup network device for the destination network device and to determine an address for the first backup network device. The attempt may be unsuccessful due to for example one or more of a network failure, a failure at the destination network device, the destination network device being unplugged or a lack of resources at the destination network device to process a call. In some cases, the lack of resources might be due to for example all call threads at the destination network device being used simultaneously. The originator network device then initiates a call to the first backup network device by attempting to establish a connection using the address of the first backup network device (step 1110). At step 1115, if the attempt is successful (yes path) and a connection is established with the first backup network device, the call is processed (step 1150). Again, the attempt at the connection with the first backup network device may be unsuccessful (no path) at step 1115 and if the attempt of step 1110 fails, then the originator network device looks up its routing information to determine which network device is to serve as a second backup network device for the destination network device and to determine an address for the second backup network device. The originator network device then initiates a call to the second backup network device by attempting to establish a connection using the address of the second backup network device (step 1120). At step 1125, if the attempt is successful (yes path) and a connection is established with the second backup network device, the call is processed (step 1150). If the attempt is unsuccessful (no path) then a busy indication is received by the originator network device to announce that no connection is possible at that time (step 1130).

Regarding processing at the destination network device, in one implementation at step 1150 the call is processed with a ringing signal being generated for answering of the call by a user of the terminal set or backup terminal set.

In a situation where the call is placed from a location outside the peer-to-peer network, interface 35 performs the actions of the originator network device described above. Interface 35 maintain information in the same manner as the peer-to-peer terminal sets regarding which terminal sets are designated as back-up terminal sets for each terminal set. Therefore, when the network of Branch Office 30 is operating in peer-to-peer mode and a call originates outside the Branch Office 30 the call enters the Branch Office 30 through interface 35. Interface 35 then attempts to contact the destination network device and if the destination network device is not connected to the network, interface 35 looks up its routing information to determine which network device is to serve as a backup network device for the destination network device.

In the method of FIG. 8, each network device is assigned two other network devices as backup network devices and as such there are up to two attempts at establishing connections with network devices designated as backup network devices (steps 1110, 1120). More generally, a network device has M other network devices designated a backup network devices with M≧1 and successive attempts at establishing connections with the M backup network devices are performed until one of the attempts is successful. If none of the attempts are successful then a busy indication is sent back to the caller as described with reference to step 1130.

In some embodiments of the invention, routing information is maintained to allow the terminal sets of the Branch Office 30 to provide call facilitating functionality locally. Some call facilitating functionalities include, but are not limited to, call processing functionalities such as call forwarding, call transfer, voice mail, call park and call park pickup, and paging, and other call related functionalities such as time synchronization, backup features, peer discovery, directory services, administrative services, and encryption. Some of these functionalities are described in U.S. Provisional Patent Application No. 60/441,481 entitled “DISTRIBUTED PEER-TO-PEER CALL TRANSFER SYSTEM, METHOD AND TELEPHONE TERMINALS” and filed Jan. 22, 2003; U.S. Provisional Patent Application No. 60/441,121 entitled “DISTRIBUTED PEER-TO-PEER CALL FORWARDING SYSTEM, METHOD AND TELEPHONE TERMINAL” and filed Jan. 21, 2003; U.S. Provisional Patent Application No. 60/434,813 entitled “DISTRIBUTED PEER-TO-PEER VOICE MAIL SYSTEM, METHOD AND TELEPHONE TERMINALS” and filed Dec. 20, 2002; U.S. Provisional Patent Application No. 60/473,877 entitled “DISTRIBUTED PEER-TO-PEER CALL PARK AND CALL PARK PICKUP SYSTEM, METHOD AND TELEPHONE TERMINALS” filed May 29, 2003; U.S. Provisional Patent Application No. 60/518,646 entitled “PEER-TO-PEER DISCOVERY SYSTEM, METHOD AND NETWORK DEVICES” filed Nov. 12, 2003; U.S. Provisional Patent Application No. 60/523,703 entitled “PEER BACK-UP IN A DISTRIBUTED PEER-TO-PEER NETWORK: SYSTEM, METHOD AND NETWORK DEVICES” filed Nov. 21, 2003; U.S. Provisional Patent Application No. 60/523,140 entitled “TIME SYNCHRONIZATION OF NETWORK DEVICES IN A NETWORK: SYSTEM, METHOD AND NETWORK DEVICE” filed Nov. 19, 2003; U.S. Provisional Patent Application No. 60/524,041 entitled “SYSTEM, METHOD AND NETWORK DEVICES FOR PAGING IN A NETWORK” filed Nov. 24, 2003; U.S. Patent Provisional Application No. 60/434,813 entitled “VOICE MAIL SYSTEM, METHOD AND NETWORK DEVICES” filed Dec. 22, 2003 U.S. patent application Ser. No. 10/760,530 entitled “CALL FORWARDING SYSTEMS, METHODS AND NETWORK DEVICES” filed Jan. 21, 2004; U.S. patent application Ser. No. 10/762,754 entitled “CALL TRANSFER SYSTEM, METHOD AND NETWORK DEVICES” filed Jan. 22, 2004; U.S. patent application Ser. No. 10/851,107 entitled “CALL PARK AND CALL PARK PICKUP SYSTEMS, METHODS AND NETWORK DEVICES” filed May 24, 2004; and U.S. patent application entitled “INFORMATION DISTRIBUTION SYSTEM, METHOD AND NETWORK DEVICE, <attorney docket number 50447-21> filed on Sep. 30, 2004, all of which are incorporated herein by reference. It is to be clearly understood, however, that embodiments of the invention are not limited by the type of call facilitating functionality being provided.

Numerous modifications and variations of the present invention are possible in light of the above teachings. It is therefore to be understood that within the scope of the appended claims, the invention may be practised otherwise than as specifically described herein.

1. A remote network comprising a plurality of interconnected packet-based network devices, the remote network adapted to:
operate in a first mode during which centralized telephony call processing services are supplied to the remote network by a main network via a connection between the remote network and the main network; and
operate in a second mode when the connection between the remote network and the main network is interrupted, wherein when in the second mode the plurality of interconnected packet-based network devices provide telephony call processing services in a distributed manner for the remote network.

2. The remote network of claim 1, wherein the remote network further comprises a continuity detector for determining continuity of the connection between the remote network and the main network.

3. The remote network of claim 1, wherein the remote network is adapted to maintain call processing information when the remote network is operating in the second mode, the call processing information to be forwarded to the main network upon switching from the second mode to the first mode following establishing of a successful connection between the remote network and the main network,
the call processing information being used to maintain configuration synchronization between the remote network and the main network.

4. The remote network of claim 3, wherein the call processing information is at least one of a group consisting of messages, call data records, configuration parameter changes, and operational logs.

5. The remote network of claim 1, wherein the remote network is adapted to receive updated call processing information from the main network when operating in the first mode, the call processing information being used to maintain configuration synchronization between the remote network and the main network.

6. The remote network of claim 1, wherein the remote network is adapted to provide peer back-up for a packet-based network device not currently available on the remote network when the remote network is operating in the second mode.

7. A packet-based network device adapted for use in a remote network, the packet-based network device adapted to:
operate in a first mode during which the packet-based network device supports centralized telephony call processing services from a main network; and
operate in a second mode when centralized telephony call processing services from the main network are interrupted, wherein when in the second mode telephony call processing services are provided in a distributed manner by a plurality of interconnected packet-based network devices in the remote network.

8. The packet-based network device of claim 7, wherein the packet-based network device further comprises a continuity detector for determining continuity of the connection between the remote network and the main network.

9. The packet-based network device of claim 7, wherein the packet-based network device is adapted to maintain call processing information when the packet-based network device is operating in the second mode, the call processing information to be forwarded to the main network upon switching from the second mode to the first mode following establishing of a successful connection between the packet-based network device the main network, the call processing information being used to maintain configuration synchronization between the remote network and the main network.

10. The packet-based network device of claim 7, wherein the packet-based network device is adapted to receive updated call processing information from the main network when operating in a first mode,
the call processing information being used to maintain configuration synchronization between the packet-based network device and the main network.

11. The packet-based network device of claim 7, wherein the packet-based network device is adapted to provide peer back-up for a packet-based network device not currently available on the remote network when the remote network is operating in the second mode.

12. A method for operation of a remote network comprising a plurality of interconnected packet-based network devices, the method comprising the steps of:
detecting an interruption in a connection with a main network;
switching from a first mode during which centralized telephony call processing services are supplied to the remote network by the main network to a second mode during which the plurality of interconnected packet-based network devices provides telephony call processing services in a distributed manner for the remote network when centralized telephony call processing services are unavailable from the main network;
providing telephony call processing services for the remote network;
detecting resumption of connectivity with the main network;
switching back to the first mode from the second mode.

13. The method of claim 12, further comprising a start-up step, the start-up step comprising the steps of:
beginning operation in the second mode; and
switching to the first mode when availability of a proxy server in the main network is detected.

14. The method of claim 13, wherein the step of beginning operation further comprises:
determining if there is a connection to the proxy server;
if there is a connection to the proxy server obtaining local configuration files for a respective packet-based network device of the plurality of packet-based network devices from the proxy server and storing the local configuration files on the respective packet-based network device;
determining if there are local configuration files stored on the respective packet-based network device;
if there are local configuration files stored on the respective packet-based network device, populating a database of the respective packet-based network device with the local configuration files;
if there are no local configuration files, populating the database of the respective packet-based network device with default information files; and
entering the second mode.

15. The method of claim 12, wherein the step of detecting an interruption comprises polling the main network at a predetermined interval with an expectation of a response,
wherein a received response indicates an uninterrupted connection between the remote network and the main network and a lack of a received response indicates an interrupted connection between the remote network and the main network.

16. The method of claim 12, wherein the step of providing telephony call processing services further comprises a step of the remote network maintaining call processing information to be forwarded to a proxy server in the main network upon switching back to the first mode from the second mode following resumption of connectivity between the remote network and the main network.

17. The method of claim 12, wherein the step of detecting resumption of connectivity comprises polling the main network at a predetermined interval with an expectation of a response,
wherein a received response indicates resumption of the connection between the remote network and the main network and a lack of a received response indicates the connection between the remote network and the main network remains interrupted.

18. The method of claim 12, wherein the step of switching back to the first mode from the second mode comprises:
passing control of telephony call processing services from the remote network to a proxy server in the main network;
pushing call processing information maintained by the remote network during the interruption of the connection between the remote network and the main network from each packet-based network device of the plurality of packet-based network devices to the proxy server.

19. A method for operation of a packet-based network device in a remote network, the method comprising the steps of:
detecting an interruption in a connection with a main network;
switching from a first mode during which centralized telephony call processing services are supplied to the packet-based network device by the main network to a second mode during which the packet-based network device is adapted to provide telephony call processing services in conjunction with a plurality of interconnected packet-based network devices in a distributed manner to the remote network when centralized telephony call processing services are unavailable from the main network;
providing telephony call processing services for the remote network;
detecting resumption of connectivity with the main network;
switching back to the first mode from the second mode.

20. The method of claim 19, further comprising a start-up step, the start-up step comprising the steps of:
beginning operation in the second mode; and
switching to the first mode when availability of a proxy server in the main network is detected.

21. The method of claim 20, wherein the step of beginning operation further comprises:
determining if there is a connection to the proxy server;
if there is a connection to the proxy server obtaining local configuration files for the packet-based network device from the proxy server and storing the local configuration files on the packet-based network device;
determining if there are local configuration files stored on the packet-based network device;
if there are local configuration files stored on the packet-based network device, populating a database of the packet-based network device with the local configuration files;
if there are no local configuration files, populating the database of the packet-based network device with default information files; and
entering the second mode.

22. A method of claim 19, wherein the step of detecting an interruption comprises polling the main network at a predetermined interval with an expectation of a response,
wherein a received response indicates an uninterrupted connection between the packet-based network device and the main network and a lack of a received response indicates an interrupted connection between the packet-based network device and the main network.

23. The method of claim 19, wherein the step of providing telephony call processing services further comprises a step of the packet-based network device maintaining call processing information to be forwarded to a proxy server in the main network upon switching back to the first mode from the second mode following resumption of connectivity between the packet-based network device and the main network.

24. The method of claim 19, wherein the step of detecting resumption of connectivity comprises polling the main network at a predetermined interval with an expectation of a response,
wherein a received response indicates resumption of the connection between the packet-based network device and the main network and a lack of a received response indicates the connection between the packet-based network device and the main network remains interrupted.

25. The method of claim 19, wherein the step of switching back to the first mode from the second mode comprises:
passing control of telephony call processing services from the packet-based network device to a proxy server in the main network;
pushing call processing information maintained by the packet-based network device during the interruption of the connection between the packet-based network device and the main network to the proxy server.

26. A system comprising:
a main network comprising a proxy server adapted to provide centralized telephony call processing services;
a remote network comprising a plurality of packet-based network devices, the remote network adapted to operate in a first mode during which centralized telephony call processing services are supplied to the remote network by a main network via a connection between the remote network and the main network and operate in a second mode when the connection between the remote network and the main network is interrupted, wherein when in the second mode the plurality of packet-based network devices provides telephony call processing services in a distributed manner for the remote network; and
the connection between the remote network and the main network.

27. The system of claim 26, wherein the connection is a wide area network (WAN).

28. The system of claim 26, wherein the connection is any one of a group consisting of a dedicated leased line, a virtual private network (VPN), and a service provider internet protocol (IP) network.

29. The system of claim 26, wherein the main network further comprises a remote network agent adapted to aid in maintaining configuration synchronization between each packet-based network device of the plurality of packet-based network devices and the main network.

30. The system of claim 29, wherein the remote network agent is adapted to notify a particular packet-based network device of the plurality of packet-based network devices of configuration parameter changes originating from the proxy server in the main network and deliver the configuration parameter changes when requested by the particular packet-based network device.

31. The system of claim 29, wherein the remote network agent is adapted to receive configuration parameter changes originating from a particular packet-based network device of the plurality of packet-based network devices and deliver the configuration parameter changes to the proxy server in the main network.

32. The system of claim 26, wherein the remote network further comprises an interface for connecting to an external network.

33. The system of according to claim 32, wherein the interface is for connecting to a public switched telephone network (PSTN).

34. A method for propagation of configuration parameter changes between a remote network agent in a main network and a remote network, the method comprising:
notifying the remote network of a configuration parameter change; and
delivering to the remote network the configuration parameter change.

35. The method of claim 34, wherein the step of notifying comprises;
the remote network agent being notified of the configuration parameter change for a packet-based network device in the remote network;
the remote network agent acknowledging receiving notification of the configuration parameter change;
the remote network agent identifying the particular packet-based network device in the remote network due for the configuration parameter change;
the remote network agent notifying the particular packet-based network device due for the configuration parameter change;
the remote network agent assigning a transaction identifier to the configuration parameter change and storing the configuration parameter change until delivery to the particular packet-based network device is confirmed; and
the remote network agent supplying notification, including the transaction identifier, of the configuration parameter change to the particular packet-based network device.

36. The method of claim 34, wherein the step of delivering comprises;
a particular packet-based network device sending a request, including a transaction identifier, to the remote network agent for delivery of the configuration parameter change;
the remote network agent delivering the configuration parameter change to the particular packet-based network device;
the remote network agent receiving a confirmation receipt after the particular packet-based network device has received the confirmation parameter change;
the remote network agent deleting the stored configuration parameter change; and
the remote network agent notifying the particular packet-based network device that the delivery of the configuration parameter change is complete.

37. A computer readable medium having embodied thereon computer programmable code for operation of a packet-based network device in a remote network, the computer programmable code comprising:
code means for detecting an interruption in a connection with a main network;
code means for switching from a first mode during which centralized telephony call processing services are supplied to the remote network by the main network to a second mode during which the packet-based network device is adapted to provide telephony call processing services in conjunction with a plurality of interconnected packet-based network devices, each having the computer programmable code, in a distributed manner for the remote network when centralized telephony call processing services are unavailable from the main network;
code means for providing telephony call processing services for the remote network;
code means for detecting resumption of connectivity with the main network;
code means for switching back to the first mode from the second mode.

38. The computer readable medium of claim 37 further comprising code means for initialization of the packet-based network device, the initialization code means comprising:
code means for beginning operation in the second mode; and
code means for switching to the first mode when availability of a proxy server in the main network is detected.

39. The computer readable medium of claim 37 further comprising code means for communicating with a remote network agent in the main network.
